(19) United States
(12) Patent Application Publication
(10) Pub. No.: US 2021/0324810 A1
(43) Pub. Date: Oct. 21, 2021

(54) Method and Device to Control the Injection of a Non-Combustible Fluid Into an Internal Combustion Engine

(71) Applicant: Hitachi Automotive Systems, Ltd., Hitachinaka-shi, Ibaraki (JP)

(72) Inventor: Takashi OKAMOTO, Hitachinaka-shi, Ibaraki (JP)

(21) Appl. No.: 17/260,650

(22) PCT Filed: Jul. 22, 2019
(86) PCT No.: PCT/JP2019/028599

§ 371 Date: Jan. 15, 2021

(30) Foreign Application Priority Data
Aug. 6, 2018 (DE) 10 2018 213 109.0

(51) Int. Cl. F02D 41/00; F02B 47/02; F02D 41/40; F02M 25/03; F02M 25/022

(52) U.S. Cl. CPC F02D 41/0025; F02B 47/02; F02M 25/0227; F02M 25/03; F02D 41/402

(57) ABSTRACT

The present subject-matter provides a method to inject a non-combustible fluid, most preferably water, into an internal combustion engine, as well as a corresponding controller 12 and a computer program product for carrying out the method by means of a computer. It is a particular technical advantage of the claimed subject-matter that it allows for suppressing knocking in an internal combustion engine without any drawbacks regarding exhaust gas emissions. This advantage is achieved by avoiding collision of fuel and water spray when injecting both fluids directly into the cylinder 100.

### TECHNICAL FIELD

The present document relates to a method to inject a non-combustible fluid, most preferably water, into an internal combustion engine, as well as a corresponding controller and a computer program product for carrying out the method by means of a computer. It is a particular technical advantage of the claimed subject-matter that it allows for suppressing knocking in an internal combustion engine without drawbacks regarding exhaust gas emissions.

### BACKGROUND ART

Patent Literature 1 describes an internal combustion engine with a water injector which is provided for introducing water directly into a combustion chamber. The water injector is arranged such that a combustion chamber surface is sprayed with water where the knocking combustion takes place.

### CITATION LIST

### Patent Literature

PTL 1: Patent Literature 1: EP 13158506 A1

### SUMMARY OF INVENTION

### Technical Problem

Water injection is an effective measure for the prevention of knocking in state of the art vehicle-internal combustion engines. In addition, the injection of water into the internal combustion engine can reduce the fuel consumption of the internal combustion engine. So far, in most cases the water injection is realized as a port water injection, which means that the water is injected into the intake ports of the internal combustion engine. However, port water injection has the technical problem that an amount of the injected water condenses on the walls of the intake ports and is therefore not available for vaporization in the combustion chamber. Therefore, direct water injection, by which the water is injected and evaporated directly in the cylinder, is more efficient with regard to suppress knocking. However, injecting the water at the same time as the fuel injection is performed could lead to increasing exhaust gas emissions because the injected water may impede the fuel evaporation of the injected fuel. A spray collision between the water and the fuel spray may disturb the mixture of fuel and air and therefore lead to increased HC- and CO-emissions. Furthermore, the evaporation of water droplets close to the fuel droplets may lead to a local temperature drop which may impede the fuel evaporation.

### Solution to Problem

The above-described technical problem is solved by the subject-matter according to the independent claims. Further preferred developments are described by the dependent claims.

The herein described and claimed subject-matter especially prevents that fuel vaporization is disturbed caused by the injection of non-combustible fluid.

According to an aspect, the claimed subject-matter comprises a method and a control device (controller) for controlling an injection of a non-combustible fluid into an internal combustion engine. Preferably the non-combustible fluid is not/not fully combusted (i.e. at least partially inert) during the combustion within a cylinder of an internal combustion engine. More preferably, the non-combustible fluid is a gas or liquid with a high latent heat, wherein the latent heat of the fluid is at least 1/10 of the evaporation enthalpy of water. Most preferably, the non-combustible fluid is water.

The internal combustion engine may have at least one (combustion) cylinder, at least one fuel injector, at least one non-combustible fluid injector (or briefly: “fluid injector”) configured to inject a non-combustible fluid into the internal combustion engine (briefly: “combustion engine” or “engine”) and at least one controller.

Preferably, the at least one fuel injector is disposed so that the fuel is injected directly into the cylinder (combustion chamber). Alternatively or in addition, the at least fuel injector can be arranged so that the non-combustible fluid is injectable into the intake port. In this case, it is preferable to have at least one intake port per cylinder.

Preferably, the at least one non-combustible fluid injector is a water injector and preferably it is disposed so that the non-combustible fluid/water is injected directly into the cylinder (combustion chamber). Alternatively or in addition, the at least one non-combustible fluid injector can be arranged so that the non-combustible fluid is injectable into the intake port. In this case, it is preferable to have at least one intake port per cylinder.

The at least one controller may be integrated into the combustion engine or, alternatively, it may be disposed at a position within a vehicle remote to the combustion engine, and the controller and the engine may be connected via one or more signal lines. Preferably, the controller may be configured to determine the start of the non-combustible fluid injection, initiate the non-combustible fluid injector at the determined start of injection and control said fluid injector to inject the non-combustible fluid into the combustion engine. Further, the controller may be configured to control the non-combustible fluid injector to inject the non-combustible fluid into the combustion chamber and/or into the intake port of the internal combustion engine.

The method may in particular comprise a step of determining a start of non-combustible fluid injection based on (predefined) injection parameters of the fuel injection. It may further comprise a step of controlling the non-combustible fluid injector to inject the non-combustible fluid into the internal combustion engine at the determined start of non-combustible fluid injection. In the context of this description the term “determining” may preferably include the meanings of “calculating” as well as “estimating” or a combination thereof.

Preferably, determining the start of non-combustible fluid injection may include that the beginning of the non-combustible fluid injection is determined by using a time signal, a crank angle, a frequency or any other signal suitable to represent a time event with regard to the non-combustible fluid injection. Further, the predefined fuel injection parameters may preferably include a start of fuel injection, a duration of fuel injection, an end of fuel injection and a fuel evaporation interval. Preferably, these fuel injection parameters may also be determined by using a time signal, a crank angle, a frequency or any other signal suitable to represent a time event and/or a time interval with regard to the fuel injection. The use of the term “time” or “timing” hereinafter may include each of the above-mentioned signals to represent a time event and/or a time interval.

Further, controlling the non-combustible fluid injector to inject the non-combustible fluid at the determined start of injection may preferably comprise initiating the fluid injector at the determined start of non-combustible fluid injection and operating the injector to inject a determined amount of non-combustible fluid into the internal combustion engine.

The method including the above described steps hence allows injecting the non-combustible fluid into the internal combustion engine at a well determined timing which prevents collision of the non-combustible fluid injection with the fuel injection and therefore avoids poor fuel evaporation as well as increased exhaust gas emissions.

Furthermore, according to the method, the start of non-combustible fluid injection may be determined such that it is outside of a fuel injection interval. The fuel injection interval may begin at the start of fuel injection and end at the end of fuel injection. Therefore, determining the start of non-combustible fluid injection such that it is outside a fuel injection interval may imply that the start of the non-combustible fluid injection is carried out before a start of fuel injection or after an end of fuel injection, regardless if a single or a multiple fuel injection scheme is performed. The risk that the fuel injection is disturbed by the non-combustible fluid injection is thereby effectively reduced.

Further, the method may determine a start of fuel injection, an end of fuel injection and a fuel evaporation interval during which the injected fuel is evaporated. Preferably, the end of the fuel evaporation interval is reached when the injected fuel is evaporated (end of fuel evaporation). Preferably, the start and the end of fuel injection as well as the duration of the fuel injection may be determined, e.g., by analyzing a timing of a control signal sent from the controller to the injector and/or by analyzing a timing of the injector current and/or by analyzing the measured needle lift of the fuel injector. Alternatively or in addition, a timing of a fuel pressure in the high pressure fuel circuit may be analyzed to determine the start, the duration and the end of fuel injection and/or the injection timing may be measured, e.g., by an optical sensor. Alternatively or in addition, it may be also possible to read predetermined values for the start, the duration and end of fuel injection out of a map stored in the controller.

Further, the fuel evaporation interval may preferably be determined with regard to at least one of the parameters engine speed, engine load, position of the fuel injector, fuel pressure, fuel temperature, fuel characteristics and amount of injected fuel. Preferably, a start of fuel evaporation may be determined at a predefined or estimated time at or after start of fuel injection and the end of fuel evaporation may be determined when the fuel is evaporated to a predefined degree. Preferably the predefined degree of evaporation for determining end of fuel evaporation may be 80% and more preferably the predefined degree of evaporation may be 95%. The evaporation interval or rather the degree of evaporation may be, e.g., read out of at least one map based on the above-mentioned parameters engine speed, engine load, position of the fuel injector, fuel pressure, fuel temperature, fuel characteristics and amount of injected fuel. For example, at high load and speed the temperatures in the inlet ports and the cylinder may be high which may lead to a fast evaporation of the fuel. However, a high load may also result in a high fuel amount, which may extend the fuel evaporation time. Furthermore, an increasing engine speed may result in a decreasing evaporation time caused by the increasing charge motion inside the combustion chamber. Further, a high fuel pressure and temperature may lead to a fast fuel evaporation whereas a fuel with poor evaporation characteristics may extend the fuel evaporation time. Preferably, all these relevant relations may be determined in advance and mapped in at least one or several characteristic map(s) in the controller.

Alternatively or in addition, the degree of fuel evaporation may be estimated by modeling a characteristic fuel evaporation time relating on injection characteristics such as fuel pressure, Reynolds and Weber number of the fuel droplets as well as the pressure and temperature conditions in the combustion chamber.

Alternatively or in addition, the evaporation degree may be measured, e.g., by an optical sensor or a sensitive temperature sensor which may determine the temperature drop caused by the evaporation heat.

The knowledge of the evaporation degree during an evaporation interval allows for deciding whether a water injection during the evaporation interval may lead to increased exhaust gas emissions caused by an interaction of the non-combustible fluid droplets with the fuel droplets. The higher the evaporation degree of the fuel, the lower the likelihood that the non-combustible fluid injection interferes the fuel evaporation.

The method may further include to determine the start of non-combustible fluid injection such that it takes place at or after the end of fuel injection. Alternatively or in addition, the start of fuel injection may also be determined before the start of fuel injection. Preferably, in case the fuel injection is carried out during the inlet stroke, the start of non-combustible fluid injection may be determined after the end of fuel evaporation to ensure an undisturbed fuel evaporation and to lower the cylinder temperature in the compression stroke. Otherwise, in case of a late direct fuel injection during the compression stroke which may, e.g., be carried out when realizing a spray-guided combustion process, there may be not enough time after the end of fuel evaporation for injecting the whole amount of non-combustible fluid before the start of the combustion. In such a case, the start of the non-combustible fluid injection may be determined to be at the end of fuel injection or at a time between the end of fuel injection and the end of fuel evaporation, provided the non-combustible fluid injection may be finished, e.g., before the ignition top dead center. If the time between the end of the fuel injection and the start of combustion or the ignition top dead center may be too short for injecting the required amount of non-combustible fluid, the start of non-combustible fluid injection may be determined to be before the start of fuel injection. This can be, e.g., the case when a fuel injection is carried out at the end of the compression stroke in order to stabilize the combustion of a lean air-fuel mixture.

Further, according to another aspect of the method, the start of non-combustible fluid injection may be determined such that it takes place at or after the end of fuel evaporation. As mentioned above, this may be a preferable case for injecting the non-combustible fluid since in that case the fuel evaporation may be totally undisturbed by the non-combustible fluid injection.

The above enables sufficient injection and evaporation time of the injected non-combustible fluid and therefore ensures the desired temperature reduction in the cylinder to suppress knocking without disturbing the fuel evaporation.

Furthermore, the method may be performed in combination with a multiple fuel injection scheme. The multiple fuel injection scheme may comprise to split fuel injection into more than one injection. Each of the multiple injections may be performed during the whole duty cycle which may comprise, e.g. in case of a four-stroke engine, an intake stroke, a compression stroke, a combustion stroke and an outlet stroke. For example, multiple fuel injections during the intake stroke are possible in order to avoid wall wetting. Further, to reduce fuel consumption at part and middle load it is preferable to perform a spray guided combustion process combusting an overall lean mixture and performing multiple fuel injections during the compression stroke. Furthermore, a very late fuel injection at the end of the combustion stroke just before opening the exhaust gas valve is conceivable in order to increase the exhaust gas temperature for catalyst heating. The non-combustible fluid injection can be adapted to each of the above fuel injection schemes concerning the fuel injection timing and the evaporation of the single fuel injections.

In this regard, the method may include determining the start of non-combustible fluid injection such that it is at or after an end of a final fuel injection, or before a start of a first fuel injection, or between two fuel injections. Most preferably, the method may determine the start of non-combustible fluid injection such that it is at or after an end of final fuel evaporation of the final fuel injection.

Particularly, in case the final injection is carried out during the intake stroke, the start of non-combustible fluid injection may be determined after the end of fuel evaporation of the final injection, to ensure an undisturbed fuel evaporation and to lower the cylinder temperature in the following compression stroke. In case of a late final fuel injection into the cylinder during the compression stroke which may, e.g., be carried out when realizing a spray-guided combustion process, the available time after the end of fuel evaporation of the final injection for injecting the non-combustible fluid may be too short before the start of combustion. The start of the non-combustible fluid injection may be determined at the end of the final fuel injection or at a time between the end of the final fuel injection and the end of the final fuel evaporation when the non-combustible fluid injection may be finished, e.g., before the ignition top dead center. If the time between the end of the final fuel injection and the start of combustion or the ignition top dead center may be too short for injecting the required amount of non-combustible fluid, the start of non-combustible fluid injection may be determined before the start of the first fuel injection or between two fuel injections. This can be, e.g., the case when a final fuel injection for combustion stabilization is carried out at the end of the compression stroke or when an even later final fuel injection is applied at the end of the combustion stroke for performing catalyst heating. The expression “between two fuel injections” may comprise “between the end of the first fuel injection and the start of the second fuel injection” and/or “between the end of the second fuel injection and the start of the third fuel injection” and/or “between the end of the third fuel injection and the start of the fourth fuel injection” and so forth until “between the end of the next to last fuel injection and the start of the final fuel injection”.

If the whole amount of non-combustible fluid is injected into the cylinder before the first fuel injection is carried out, it is necessary that sufficient time, e.g., during the intake stroke between gas exchange top dead center and the start of the first fuel injection is available. In order to avoid wetting of the piston by the injected non-combustible fluid, the controller may require a safety margin between GTDC and the start of non-combustible fluid injection.

In case the whole amount of non-combustible fluid is injected into the cylinder during a time between two fuel injections, it is necessary that sufficient time between the end of the first fuel injection and the start of the second fuel injection is available.

If fuel injection schemes are applied which do not fulfill the above requirements, such as providing sufficient time or the like, the non-combustible fluid injection may be split up into multiple non-combustible fluid injections. Furthermore, a start of each non-combustible fluid injection may be determined such that it is outside of a fuel injection interval. Determining the start of non-combustible fluid injection such that it is outside a fuel injection interval may preferably mean that the start of the non-combustible fluid injection is carried out before a start of a fuel injection or after an end of a fuel injection, regardless if a single or a multiple fuel injection scheme is performed.

Even further, an end of a non-combustible fluid injection may be determined such that it is at or before a start of a following fuel injection. A following fuel injection may comprise any fuel injection which may be performed after a non-combustible fluid injection, regardless if single or multiple fuel injection scheme and/or single or multiple non-combustible fuel injection scheme is performed.

Since the start of a non-combustible fluid injection may be carried out outside of a fuel injection interval and the end of a non-combustible fluid injection may be carried out before the start of the following fuel injection, the risk that non-combustible fluid is injected during a fuel injection is avoided or at least decreased. Hence, the fuel evaporation is not interfered by non-combustible fluid droplets which may decrease the gas temperature and therefore retard the fuel evaporation.

Further, the claimed subject matter may include a controller of an internal combustion engine, preferably the ECU, which may be configured to carry out the method according to the above described method/aspects of the method, as well as an internal combustion engine which may include the controller. “Include” may mean that the controller is physically integrated with the engine or that it is remotely arranged, however, connected thereto by signal lines and the like.

Further, the internal combustion engine is preferably a gasoline engine and further preferably the injected fluid is injected directly into the cylinder for improving the fuel efficiency.

Further, the claimed subject matter may include a computer program product storable in a memory comprising instructions which, when carried out by a computer or a computing unit, cause the computer to perform the above described method or aspects thereof, as well as a computer-readable [storage] medium comprising instructions which, when executed by a computer, cause the computer to carry out said method or aspects thereof.

### Advantageous Effects of Invention

Summarizing, the claimed subject-matter allows avoiding increased exhaust gas emissions by preventing interaction between the fuel and the non-combustible fluid injection, in particular when the non-combustible fluid is injected directly into the cylinder of the internal combustion engine.

In the following the claimed subject-matter will be further explained based on at least one preferential example with reference to the attached exemplary drawings.

### BRIEF DESCRIPTION OF DRAWINGS

FIG. 1 depicts a schematic view of a cylinder of an internal combustion engine with water injection into the cylinder,

FIG. 2 shows a flow chart with an example for determining a start of water injection,

FIG. 3 ((3a)-(3c)) schematically depicts characteristic signals of a high-pressure fuel injector,

FIG. 4 schematically presents two fuel evaporation curves determined at different temperatures,

FIG. 5 ((5a)-(5d)) illustrates different water injection strategies when applying single fuel injection,

FIG. 6 ((6a)-(6d)) depicts different water injection strategies when applying multiple fuel injections,

FIG. 7 ((7a)-(7b)) shows further water injection strategies when applying multiple fuel injections.

### DESCRIPTION OF EMBODIMENTS

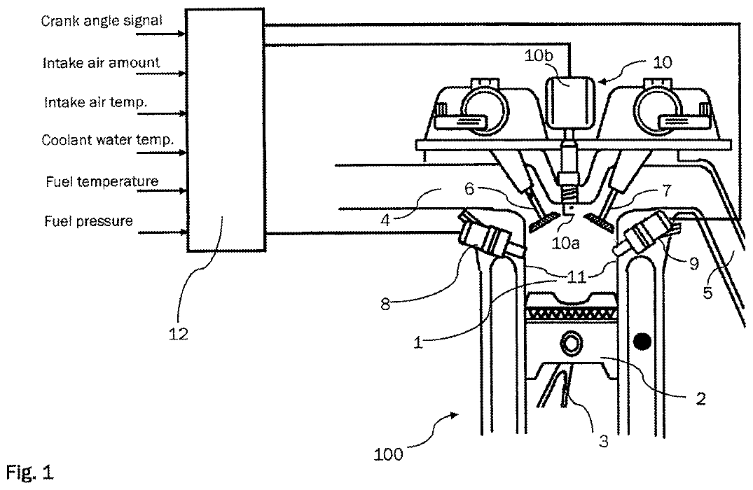

FIG. 1 depicts an exemplary cylinder 100 of an otherwise unspecified internal combustion engine, which may have more than one cylinder 100. The engine may, e.g., have two, three, four, six, eight or less/more cylinders 100. The cylinder 100 comprises a combustion chamber 1 in which a piston 2 with a connecting rod 3 is disposed allowing it to travel. The connecting rod 3 is connected to a crankshaft (not depicted) that can be a crankshaft as known.

An (air) intake port 4 with an intake valve 6 as well as an exhaust port 5 with an exhaust valve 7 are connected to the combustion chamber 1. Ambient air is drawn into the combustion chamber 1 through the intake port 4. Exhaust gases are discharged from the combustion chamber 1 via the exhaust port 5. A spark ignition unit 10 comprising a spark plug 10a and an ignition coil 10b is attached to the internal combustion engine. The spark ignition unit 10 preferably offers a variable spark duration or multi-spark ignition. The internal combustion engine (or briefly: “combustion engine” or “engine”) may have one or more spark ignition units 10. Preferably, it has at least one spark ignition unit(s) 10 per cylinder 100. The spark plug 10a as well as a fuel injector 8, or at least parts thereof, are connected to the inside of the combustion chamber 1 so that a spark and fuel can be introduced/injected into the combustion chamber 1. The high-pressure fuel supply of the fuel injector 8 is not depicted. The fuel injector 8 may preferably be a direct fuel injector 8. Further, the fuel injector 8 may preferably be an electrohydraulic fuel injector or a piezoelectric fuel injector. The fuel injector 8 may be located lateral at the cylinder wall 11 as depicted in FIG. 1 but it may also be located at a central position within the cylinder close to the spark plug 10a.

Further, a non-combustible fuel injector 9 is connected to the inside of the combustion chamber 1 of the cylinder 100 to inject water directly into the combustion chamber 1. Since most preferably the liquid to be injected is water, even though other liquids having a high evaporation enthalpy may be used as well, the term “water injector” is used as one specific example for a non-combustible fuel injector 9. The water injector 9 may be a low-pressure injector with an injection pressure of up to 15 bar or, preferably, a high-pressure injector with an injection pressure of more than 15 bar. The water injector 9 may be located lateral at the cylinder wall 11 as depicted in FIG. 1 but may also be located at a central position in the cylinder close to the spark plug 10a. As an alternative to the water injector 9 connected to the cylinder wall 11 (as shown in FIG. 1), or in addition thereto, one or more water injectors 9 may be connected to the intake port 4 of one cylinder 100.

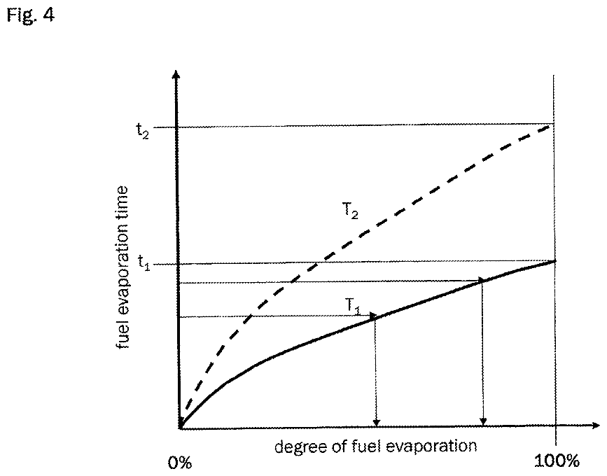

A controller 12 for controlling the water injection into the internal combustion engine is further shown by FIG. 1. The controller 12 determines the amount of water to be injected by the injector 9 and the timing of the water injection in accordance with predefined internal combustion engine states. For example, the controller 12 may use a map, a table or the like to determine the amount of water to be injected depending on the engine state, which may be defined by parameters and which are used to look up the amount of water to be injected. Subsequently, the controller 12 determines the start of water injection based on the injection parameters of the fuel injection. The fuel injection parameters, such as start of fuel injection(s), duration of the fuel injection(s) and end of fuel injection(s) are also determined by the controller. For example, the controller 12 may use a map, a table or the like to determine said fuel injection parameters depending on the engine state, too. Furthermore, at least one map or table and/or a model to determine the degree of fuel evaporation may be implemented in the controller 12 as described in the following with regard to FIG. 4.

The controller is electrically connected to the spark ignition unit 10, the direct fuel injector 8 and the water injector 9 and controls the multiple units/injectors/actuators. The controller 12 may, e.g., be the engine control unit (ECU).

The controller 12 may also be any other control unit, and signal line connections between the controller 12 and the controlled units may differ from the example of FIG. 1. For example, there may be a plurality of controllers 12 which may control subgroups of the controlled units, e.g. one controller 12-1 may control only fuel injectors, another controller 12-2 may control only water injectors 9 and so on. Even further, if there is a plurality of controllers 12, these controllers 12 may be interconnected with each other hierarchically or in another way.

Further, pressure sensors which are not shown may be disposed at the combustion chamber wall 11 so that the pressure within the combustion chamber 1 can be measured. Measuring the pressure within the combustion chamber 1 can support a feedback control of the amount of water to be injected.

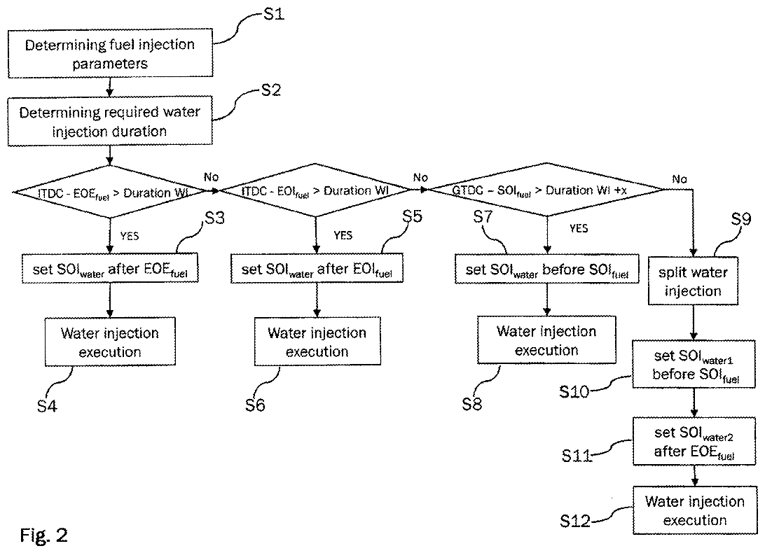

FIG. 2 shows a flow chart of one specific example for determining a start of water injection. In a first step S1, the fuel injection parameters, such as start of fuel injection, end of fuel injection and end of evaporation of the injected fuel, are calculated and/or estimated. Subsequently or in parallel, in a further step S2, the required water injection duration is calculated, wherein the engine conditions define the required water amount which results in the water injection duration depending on the water pressure and the water injector flow rate. If the time between the end of fuel evaporation (EOE_{fuel}) and the ignition top dead center (ITDC) is longer than the water injection duration, the start of water injection (SOI_{water}) is set after the end of fuel evaporation (EOE_{fuel}, S3) and water injection is executed (S4). If not, it is checked whether the time between the end of fuel injection (EOI_{fuel}) and the ignition top dead center (ITDC) is longer than the water injection duration. In this case, the start of water injection (SOI_{water}) is set to be after the end of fuel injection (EOI_{fuel}, S4), more precisely, the start of water injection is set between the end of fuel injection (EOI_{fuel}) and the end of fuel evaporation (EOE_{fuel}), and water injection is carried out (S6). If the time between end of fuel injection (EOI_{fuel}) and ignition top dead center (ITDC) is shorter than the water injection duration, it is checked whether a time between gas exchange top dead center (GTDC) and a start of fuel injection (SOI_{fuel}) is longer than the water injection duration supplemented by a safety margin (x), which is necessary to ensure that the piston is not wetted by the water injection. If there is sufficient time between GTDC and SOI_{fuel}, the start of water injection (SOI_{water}) is set to be before the start of fuel injection (SOI_{fuel}). If not, the whole amount of required water is split into several water injections (S9). For example, as shown in FIG. 2, two water injections may be applied, wherein the start of the first water injection (SOI_{water1}) is set before the start of fuel injection (SOI_{fuel}, S10), the start of the second water injection (SOI_{water2}) may be set after the end of fuel evaporation (EOE_{fuel}, S11) and water injection may be performed (S12). It should be noted that the above described procedure illustrates one possible example to determine the start of water injection such that collision between water and fuel injection is prevented.

Furthermore, it is possible to omit some steps or carry out the steps in a different order. For example, it is possible to carry out only the steps S1 to S4 of the flowchart illustrated in FIG. 2, which include determining the injection parameters (S1), calculating the water injection duration (S2), setting the start of water injection (SOI_{water}) after the end of fuel evaporation (EOE_{fuel}, S3), if the time between the end of fuel evaporation (EOE_{fuel}) and the ignition top dead center (ITDC) is longer than the water injection duration, and executing water injection (S4).

In another example, the condition “ITDC−EOE_{fuel}>Duration WI” can be left out and the method can execute only the steps S1, S2, S5 and S6, which comprise determining the injection parameters (S1), calculating the water injection duration (S2), setting the start of water injection (SOI_{water}) after the end of fuel injection (EOI_{fuel}, S5), if the time between the end of fuel injection (EOI_{fuel}) and the ignition top dead center (ITDC) is longer than the water injection duration, and executing water injection (S6).

In a further example, it is feasible to carry out the steps S7 and S8 right after the steps S1 and S2 by only considering the condition “GTDC−SOI_{fuel}>Duration WI+x”. Furthermore, as another example, the steps S1, S2 and S9 to S12 can be carried out without considering a timing condition.

It should be understood, as far as the person skilled in the art is able to perform the modification without inventive activity, that the method is not limited to the described examples and that the method steps can be carried out in a different order and can be combined in a different way. Furthermore, individual steps can be left out and additional steps and conditions can be included.

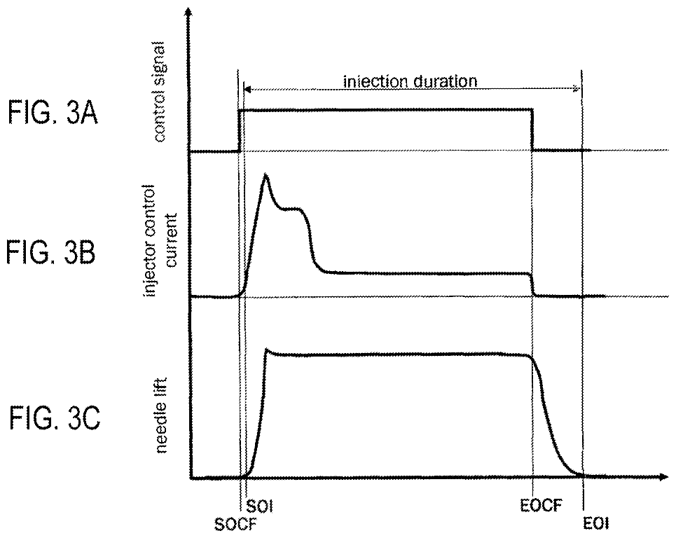

FIGS. 3 ((3a) to (3c)) shows schematic characteristic signals for controlling a high-pressure fuel injector 8. FIG. 3 (3a) depicts an example of a control signal sent from a controller 12, e.g. the ECU of the internal combustion engine, to a high-pressure fuel injector 8 in order to initiate a start of injection (SOI) and to control an injection duration.

FIG. 3 (3b) schematically illustrates a control current curve for controlling a high-pressure fuel injector 8. The control current rises at a start of current feed (SOCF) up to a boosting peak which may be necessary for rapidly accelerating the injector needle and therefore ensuring a fast opening thereof. When the maximum needle lift may be reached the control current may be lowered to a value necessary to keep the needle open. The control current may be shut off in case the controller 12 may switch off the control signal.

FIG. 3 (3c) depicts a schematic needle lift curve of a high-pressure fuel injector 8 which, e.g., may be measured or estimated. It has to be noted that the rise in the control signal (start of current feed, SOCF) may not be equal to the “real” start of injection (SOI), namely the opening time of the injector needle, since there may be a delay time after start of current feed (SOCF) until the needle may open. Furthermore, it may take additional time until the needle may be closed after switching of the injector control current. Therefore the “real” end of injection (EOI) may take place a predefined time after the end of current feed (EOCF). In case the injection parameters, such as start and end of fuel injection may be determined by analyzing the control signal or the injector control current, the particular delay times for opening and closing the needle have to be considered.

Two fuel evaporation curves are schematically illustrated in FIG. 4, wherein the curves each represent a fuel evaporation process at a given temperature, e.g., two different gas temperatures in the combustion chamber. In the presented example, temperature T1 is higher than temperature T2. Therefore, the time t₁ until the fuel is fully evaporated (100% degree of evaporation) is shorter than the time t₂. Furthermore, with regard to the illustrated evaporation curves, it is possible to determine a degree of fuel evaporation after a certain evaporation time in order to estimate the amount of liquid fuel remaining in the combustion chamber 1 (depicted by the arrows in the diagram of FIG. 4). The information about the degree of fuel evaporation at a certain time after start of fuel injection can be used to decide whether the start of water injection may be initiated and to estimate the influence of the water injection on the exhaust gas emissions. There may be a plurality of fuel evaporation curves similar to the curves depicted in FIG. 4 determined in advance and stored in the controller. These curves may depend on different boundary conditions depending on the engine state, such as engine speed, engine load, position of the fuel injector 8, fuel pressure, fuel temperature, fuel characteristics and amount of injected fuel. Alternatively or in addition, the evaporation curves may be estimated by a model calculated in the controller 12 depending on current boundary conditions, such as pressure and temperature in the combustion chamber 1, fuel pressure as well as Reynolds and Weber number of the fuel droplets. The knowledge about the fuel evaporation degree at a certain time after start of fuel injection can be used for determining the optimal start of water injection.

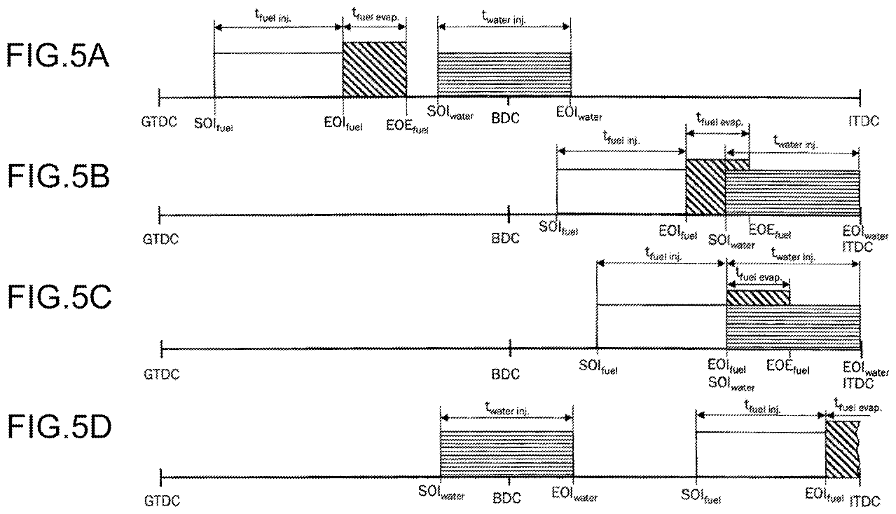

The FIGS. 5 ((5a) to (5d)) illustrates different water injection strategies when using single fuel injection, wherein the fuel is injected directly into the combustion chamber 1.

FIG. 5 (5a) shows the case in which the water injection is carried out after the fuel injection and the fuel evaporation have taken place. The fuel injection can be executed during the intake stroke and it can start after a predefined margin to the gas exchange top dead center (GTDC). The fuel evaporation interval t_{fuel evap.}, e.g., starts at the end of fuel injection (EOI_{fuel}) in this case and the fuel is assumed to be fully evaporated (100% degree of evaporation) at the end of fuel evaporation (EOE_{fuel}), which is to be determined (estimated or measured) before bottom dead center. Therefore, the start of the water injection (SOI_{water}) can be carried out at the end of the intake stroke without disturbing the fuel evaporation, which will lead to a reduction of the gas temperature in the compression stroke in order to suppress knocking while it avoids to influence the exhaust gas emissions.

In FIG. 5 (5b) fuel injection during the compression stroke is shown. In the example of FIG. 5 (5b), the time between end of fuel evaporation (EOE_{fuel}) and ignition top dead center (ITDC) is too short to inject the required amount of water completely before ITDC. Therefore, the start of water injection (SOI_{water}) initiated during the fuel evaporation interval, which in this case may start at the end of fuel injection (EOI_{fuel}) and end at the marked end of fuel evaporation (EOE_{fuel}).

FIG. 5 (5c) depicts a similar injection scheme as FIG. 5 (5b). The fuel injection however, is carried out later during the compression stroke. Therefore, the start of water injection is initiated at the end of fuel injection (EOI_{fuel}) so that the water may enter into the combustion chamber 1 before the combustion takes place (EOI_{water} at ITDC). Even though the fuel evaporation may be partly affected by the injection, the exhaust gas emission behavior of the engine is not deteriorated.

FIG. 5 (5d) depicts a very late fuel injection during the compression stroke, which can be used for combustion stabilization realizing a spray guided combustion process. In this case, the end of fuel injection (EOI_{fuel}) applied just before ITDC and therefore the water injection is performed before the start of fuel injection (SOI_{fuel}) at the beginning of the compression stroke.

It should be noted that in the cases shown in FIGS. 5 (5b) and (5c) it is also possible to inject the water before the start of fuel injection (SOI_{fuel}). However, for efficiently suppressing knocking, a water injection carried out as late as possible during the compression stroke is preferable to utilize the evaporation heat of the water at the right time just before the combustion.

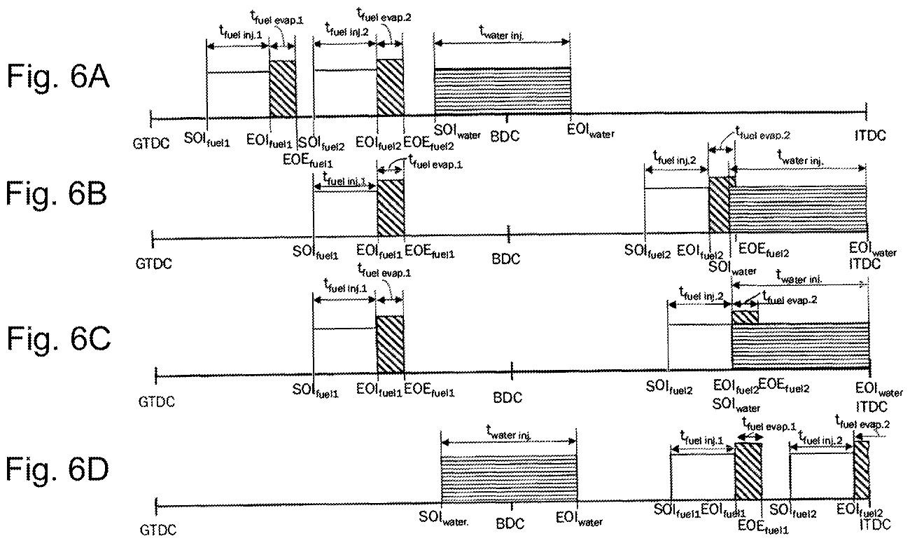

FIGS. 6 ((6a) to (6d)) illustrates different water injection strategies when using multiple fuel injection scheme, wherein the fuel is injected directly into the combustion chamber 1 and, in the examples two fuel injections per cycle are shown.

FIG. 6 (6a) shows a case in which the water injection is carried out after the second fuel injection and the fuel evaporation thereof have taken place. The two fuel injections are executed during the intake stroke starting after a predefined margin to the gas exchange top dead center (GTDC), wherein the start of the second fuel injection (SOI_{fuel2}) is performed after a predefined margin to the end of the first fuel injection (EOI_{fuel1}). The fuel evaporation intervals t_{fuel evap.1} and t_{fuel evap.2} may, e.g., in this case start at the end of each fuel injection (EOI_{fuel1} and EOI_{fuel2}) and the fuel may be fully evaporated (100% degree of evaporation) at the end of each fuel evaporation (EOE_{fuel1} and EOE_{fuel2}), wherein the end of the second fuel evaporation (EOE_{fuel2}) may be determined (estimated or measured) before the bottom dead center. Therefore, the start of the water injection (SOI_{water}) can be carried out at the end of the intake stroke without disturbing the fuel evaporation, which leads to a reduction of the gas temperature in the compression stroke in order to suppress knocking and to avoid a deterioration of the exhaust gas emissions.

In FIG. 6 (6b) a multiple fuel injection is shown. The first fuel injection is performed during the intake stroke and the second fuel injection during the compression stroke. In the presented example, the time between the end of the second fuel evaporation (EOE_{fuel2}) and the ignition top dead center (ITDC) is too short to inject the required amount of water completely after the second fuel evaporation (EOE_{fuel2}). Therefore, the start of water injection (SOI_{water}) initiated during the fuel evaporation interval of the second fuel injection (t_{fuel evap.2}), which in this case may start at the end of the second fuel injection (EOI_{fuel2}) and end at the marked end of the second fuel evaporation (EOE_{fuel2}).

FIG. 6 (6c) depicts a similar injection scheme as FIG. 6 (6b). The second fuel injection is carried out later in the compression stroke. The start of water injection is initiated at the end of the second fuel injection (EOI_{fuel2}) so that the water can enter in the combustion chamber 1 before the combustion takes place (EOI_{water} at ITDC). Even though the fuel evaporation may be partly affected by the water injection, the exhaust gas emission behavior of the engine is not deteriorated.

FIG. 6 (6d) depicts a multiple fuel injection scheme which is carried out during the compression stroke. Such fuel injection scheme can be applied when realizing a spray guided lean combustion process in order to reduce fuel consumption at part load. The late second injection can be used for combustion stabilization when combusting an overall lean air fuel mixture. In the present case, the end of the second fuel injection (EOI_{fuel}) is applied just before ITDC and therefore the start of the water injection (SOI_{water}) is performed before the start of the first fuel injection (SOI_{fuel1}) at the end of the intake stroke.

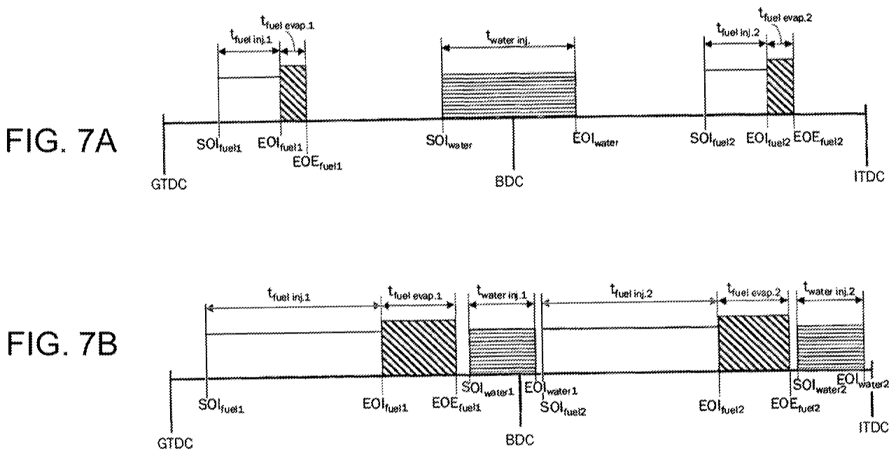

Further fuel and water injection schemes are presented in the FIGS. 7 ((7a) and (7b)).

In FIG. 7 (7a) a multiple fuel injection is shown, wherein the first fuel injection is carried out during the intake stroke and the second fuel injection is carried out during the compression stroke. This fuel injection scheme allows for injecting the water between the two fuel injections, wherein the start of the water injection (SOI_{water}) is performed at the end of the intake stoke before BDC.

It has to be noted, that in the examples as shown in the FIGS. 6 ((6b) and (6c)) it is also possible to perform the water injection between the two fuel injections. Nevertheless, it is preferable to inject the water after the final fuel injection in order to efficiently suppress knocking.

FIG. 7 (7b) depicts an example in which it is not possible to realize one single water injection since there is not enough time before, between or after the fuel injections for injecting the required whole amount of water during the intake or the compression stroke. Therefore, in this example the water injection is split into two injections which are carried out between the two fuel injections and after the second fuel injection.

It is summarized that the present subject-matter enables to efficiently suppress knocking without drawbacks regarding increasing exhaust gas emissions caused by a collision of water and fuel injection.

While the above describes a particular order of operations performed by certain aspects and examples, it should be understood that such order is exemplary, as alternatives may perform the operations in a different order, combine certain operations, overlap certain operations, or the like. References in the specification to a given aspect indicate that the aspect described may include a particular feature, structure, or characteristic, but every aspect may not necessarily include the particular feature, structure, or characteristic. The features which are described herein and which are shown by the Figures may be combined. The herein described and claimed subject-matter shall also entail these combinations as long as they fall under scope of the independent claims.

It should again be noted that the description and drawings merely illustrate the principles of the proposed methods, devices and systems. It will thus be appreciated that those skilled in the art will be able to devise various arrangements that, although not explicitly described or shown herein, embody the principles of the claimed subject-matter and are included within its spirit and scope.

Furthermore, it should be noted that steps of various above-described methods and components of described systems can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

In addition, it should be noted that the functions of the various elements described herein may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

Finally, it should be noted that any block diagrams herein represent conceptual views of illustrative circuitry embodying the principles of the claimed subject-matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Further, although citations of other claims in dependent claims are single citations in order to make the description of the dependent claims easy to understand, the present invention includes configurations in which a plurality of proceeding claims are cited in the dependent claim(s) and a plurality of multiple dependent claims are cited in the dependent claim(s).

Again summarizing, the present subject-matter offers a method and the related device to avoid increased exhaust gas emissions caused by a collision of a fuel and a water injection in case the water is injected directly into the cylinder.

### REFERENCE SIGNS LIST

1: combustion chamber, 2: piston, 3: connecting rod, 4: intake port, 5: exhaust port, 6: intake valve, 7: exhaust valve, 8: (high-pressure) fuel injector, 9: non-combustible fluid/water injector, 10: spark ignition, 10a: spark plug, 10b: ignition coil, 11: cylinder wall, 12: controller, 100: cylinder, SOI: start of injection, EOI: end of injection, EOE: end of evaporation, SOCF: start of current feed, EOCF: end of current feed, ITDC: ignition top dead center, GTDC: gas exchange top dead center, BDC: bottom dead center, and WI: water injection.

1. Method for controlling injection of a non-combustible fluid into an internal combustion engine, the internal combustion engine having at least one cylinder, at least one fuel injector configured to inject fuel into the internal combustion engine, at least one non-combustible fluid injector configured to inject the non-combustible fluid into the internal combustion engine and at least one controller, comprising:
determining a start of non-combustible fluid injection based on injection parameters of the fuel injection, and
controlling the non-combustible fluid injector to inject the non-combustible fluid into the internal combustion engine at the determined start of non-combustible fluid injection.

2. Method according to claim 1, further comprising determining the start of non-combustible fluid injection such that it is outside of a fuel injection interval.

3. Method according to claim 1, further comprising determining the start of non-combustible fluid injection such that it is at or after the end of fuel injection, or before the start of fuel injection.

4. Method according to claim 1, further comprising determining the start of non-combustible fluid injection such that it is at or after the end of fuel evaporation.

5. Method according to claim 1, further comprising performing non-combustible fluid injection in combination with a multiple fuel injection.

6. Method according to claim 5, further comprising determining the start of non-combustible fluid injection such that it is at or after an end of a final fuel injection, before a start of a first fuel injection, and/or between two fuel injections.

7. Method according to claims 5, further comprising determining the start of non-combustible fluid injection such that it is at or after an end of a final fuel evaporation.

8. Method according to claim 1, further comprising splitting the non-combustible fluid injection in multiple non-combustible fluid injections, wherein a start of each non-combustible fluid injection is determined such that it is outside of a fuel injection interval.

9. Method according to claim 1, further comprising determining an end of a non-combustible fluid injection such that it is at or before a start of a following fuel injection.

10. Controller for an internal combustion engine comprising:
at least one cylinder, at least one fuel injector configured to inject fuel into the internal combustion engine and at least one non-combustible fluid injector configured to inject a non-combustible fluid into the internal combustion engine, wherein the controller is configured to perform the method according to claim 1.

11. Internal combustion engine including the controller of claim 10.

12. A computer program product storable in a memory comprising instructions which, when carried out by a computer, cause the computer to perform the method according to claim 1.
